(19) United States
(12) Patent Application Publication
(10) Pub. No.: US 2021/0004511 A1
(43) Pub. Date: Jan. 7, 2021

(54) MULTI-LEVEL OCCUPANT MOVEMENT SIMULATION METHOD AND APPARATUS, AND STORAGE MEDIUM

(71) Applicant: Tsinghua University, Beijing (CN)

(72) Inventors: Qingshan JIA, Beijing (CN); Jingxian TANG, Beijing (CN); Zhiling LIU, Beijing (CN)

(21) Appl. No.: 17/023,889

(22) Filed: Sep. 17, 2020

Related U.S. Application Data
(63) Continuation of application No. PCT/CN2019/098279, filed on Jul. 30, 2019.

(30) Foreign Application Priority Data
Jun. 13, 2019 (CN) 201910512150.3

(51) Int. Cl. G06F 30/20; G06F 30/13

(52) U.S. Cl. CPC G06F 30/20; G06F 2111/10; G06F 30/13

(57) ABSTRACT

The disclosure provides a multi-level occupant movement simulation method and apparatus. The method includes: establishing a multi-level architectural topology according to a structure of a building; obtaining a schedule of multiple occupants in a simulation experiment; obtaining a time period of stay of each occupant of the multiple occupants according to the schedule, and simulating, according to a preset simulation algorithm, the state transition position of each occupant in the multi-level architectural topology during the time period of stay; and calculating an operating energy consumption parameter of the building according to the state transition position.

### CROSS-REFERENCE TO RELATED APPLICATION

The present application is a continuation of International Application No. PCT/CN2019/098279, filed Jul. 30, 2019, which claims priority to Chinese Patent Application No. 201910512150.3, filed Jun. 13, 2019, the entire disclosures of which are incorporated herein by reference.

### FIELD

The present disclosure relates to a technical field of building energy consumption simulation, in particular to a multi-level occupant movement simulation method and apparatus, and a non-transitory computer-readable storage medium.

### BACKGROUND

At present, based on the Gaussian mixture model, the number of people in each area of a building is estimated mainly with the help of sensors (video, infrared, etc.) deployed in the building, and according to the number of people in each area, the movement process of occupants can be simulated through regular schedules of occupants.

However, this estimation method using sensors deployed in the building requires a large number of sensors to be deployed, which does not take schedules and individual differences into consideration. Therefore, there is a large gap between the estimated and the real occupancy distribution in buildings.

### SUMMARY

The present disclosure aims to solve the technical problems in the related art at least to some extent.

Embodiments of the present disclosure propose a multi-level occupant movement simulation method, including: establishing a multi-level architectural topology according to a structure of a building, in which a first layer of the multi-level architectural topology includes a floor architectural topology, a second layer of the multi-level architectural topology includes a floor area architectural topology, and a third layer of the multi-level architectural topology includes a gridded architectural topology in a floor area; obtaining a schedule of multiple occupants in a simulation experiment; obtaining a time period of stay of each occupant according to the schedule, and simulating, according to a preset simulation algorithm, the state transition position of each occupant in the multi-level architectural topology during the time period of stay; and calculating an operating energy consumption parameter of the building according to the state transition position.

Embodiments of the present disclosure propose a multi-level occupant movement simulation apparatus, including: one or more processors; a memory storing instructions executable by the one or more processors; in which the one or more processors are configured to: establish a multi-level architectural topology according to a structure of a building, in which a first layer of the multi-level architectural topology includes a floor architectural topology, a second layer of the multi-level architectural topology includes a floor area architectural topology, and a third layer of the multi-level architectural topology includes a gridded architectural topology in a floor area; obtain a schedule of multiple occupants in a simulation experiment; obtain a time period of stay of each occupant of the multiple occupants according to the schedule, and simulate, according to a preset simulation algorithm, the state transition position of each occupant in the multi-level architectural topology during the time period of stay; and calculate an operating energy consumption parameter of the building according to the state transition position.

Embodiments of the present disclosure proposes a non-transitory computer-readable storage medium. When the computer program is executed by a processor, a multi-level occupant movement simulation method is implemented. The method includes: establishing a multi-level architectural topology according to a structure of a building, in which a first layer of the multi-level architectural topology includes a floor architectural topology, a second layer of the multi-level architectural topology includes a floor area architectural topology, and a third layer of the multi-level architectural topology includes a gridded architectural topology in a floor area; obtaining a schedule of multiple occupants in a simulation experiment; obtaining a time period of stay of each occupant of the multiple occupants according to the schedule, and simulating, according to a preset simulation algorithm, the state transition position of each occupant in the multi-level architectural topology during the time period of stay; and calculating an operating energy consumption parameter of the building according to the state transition position.

The additional aspects and advantages of the present disclosure will be partially given in the following description, and some will become obvious from the following description, or be understood through the practice of the present disclosure.

### BRIEF DESCRIPTION OF THE DRAWINGS

The above and/or additional aspects and advantages of the present disclosure will become obvious and easy to understand from the following description of the embodiments in conjunction with the accompanying drawings, in which:

FIG. 1 is a schematic flowchart of a multi-level occupant movement simulation method provided by an embodiment of the present disclosure;

FIG. 2 is a display diagram of a floor connection graph and an area connection graph according to an embodiment of the present disclosure;

FIG. 3 is a display diagram of an area grid model according to an embodiment of the present disclosure;

FIG. 4 is a schematic diagram of a multi-level occupant movement simulation method according to an embodiment of the present disclosure; and

FIG. 5 is a schematic structural diagram of a multi-level occupant movement simulation apparatus provided by an embodiment of the present disclosure.

### DETAILED DESCRIPTION

The embodiments of the present disclosure are described in detail below. Examples of the embodiments are shown in the accompanying drawings, in which the same or similar reference numerals indicate the same or similar elements or elements with the same or similar functions. The embodiments described below with reference to the accompanying drawings are exemplary, and are intended to explain the present disclosure, but should not be construed as limiting the present disclosure.

The following describes the multi-level occupant movement simulation method and apparatus according to the embodiments of the present disclosure with reference to the accompanying drawings.

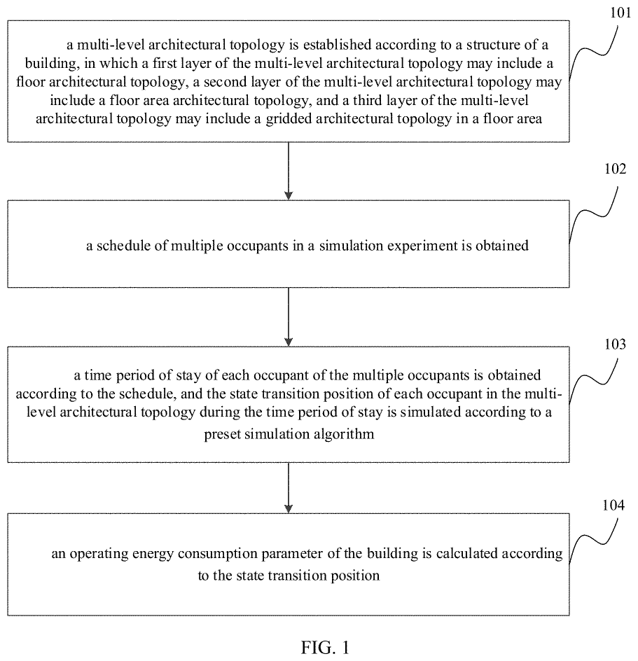

FIG. 1 is a schematic flowchart of a multi-level occupant movement simulation method provided by an embodiment of the present disclosure.

In view of the foregoing embodiment, the embodiment of the present disclosure provides a multi-level occupant movement simulation method. As shown in FIG. 1, the multi-level occupant movement simulation method includes the following steps:

At step 101, a multi-level architectural topology is established according to a structure of a building, in which a first layer of the multi-level architectural topology may include a floor architectural topology, a second layer of the multi-level architectural topology may include a floor area architectural topology, and a third layer of the multi-level architectural topology may include a gridded architectural topology in a floor area.

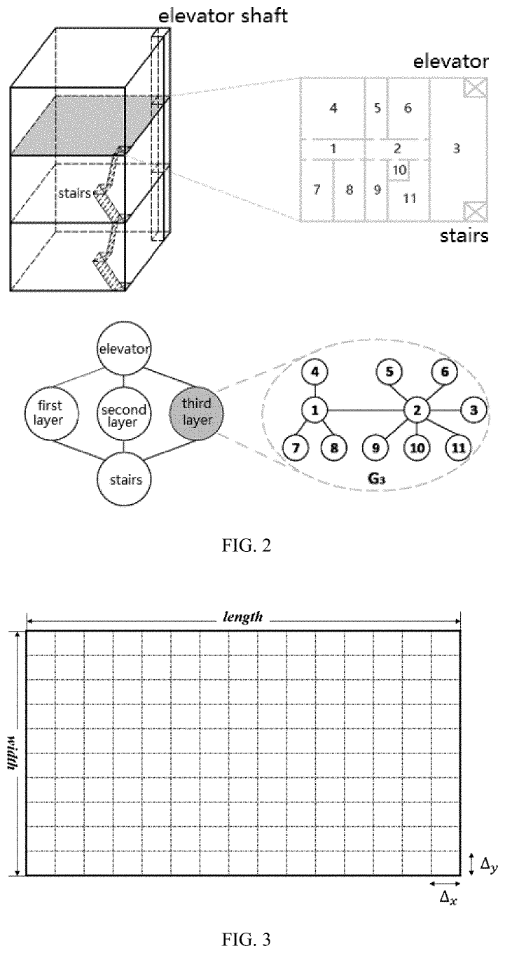

Specifically, as shown in FIG. 2, the floor architectural topology is constructed according to a connectivity relation among floors of the building, in which a connectivity relation among floor nodes in the floor architectural topology corresponds to the connectivity relation among the floors, and the floor nodes may include nodes of floors, nodes of stairs and nodes of elevators. The floor area architectural topology is constructed according to a connectivity relation among floor areas of the building, in which a connectivity relation of area nodes in the floor area architectural topology corresponds to the connectivity relation among the floor areas. Each non-corridor area in the floor area may be divided into a plurality of floor sub-areas according to a preset size, and constructing the gridded architectural topology in the floor area according to the floor sub-areas, in which a connectivity relation of the floor sub-area nodes in the gridded architectural topology corresponds to a connectivity relation among the floor sub-areas.

It can be understood that, as a possible implementation of the embodiment of the present disclosure, a single connected graph depicts the architectural topology, in which nodes represent areas within the building, edges represent connected relationships among areas. The first layer contains the floor architectural topology, and each node represents a floor. The second layer contains the floor area architectural topology, and each node represents a building area. For an N-story building, each floor is represented by a connected graph, and there are N connected graphs in total. The third layer contains the gridded architectural topology of a floor area, each non-corridor area in the floor areas is divided into multiple floor sub-areas according to the preset size. As shown in FIG.

3, each non-corridor area of a length length and a width width is divided into the plurality of floor sub-areas with a length step size of Δₓ and a width step size of Δ_{y}, each floor area has a size of N_{div,x}×N_{div,y}, where

$${N}_{div , x} = \frac{length}{{Δ}_{x}} , {N}_{div , y} = \frac{width}{{Δ}_{y}} .$$

At step 102, a schedule of multiple occupants in a simulation experiment is obtained.

Specifically, according to the obtained schedules of multiple occupants, the time period during which they stay inside the building is obtained. In this embodiment, the schedule may be regular schedule such as commuting, meeting, and meal time of the occupants.

At step 103, a time period of stay of each occupant of the multiple occupants is obtained according to the schedule, and the state transition position of each occupant in the multi-level architectural topology during the time period of stay is simulated according to a preset simulation algorithm.

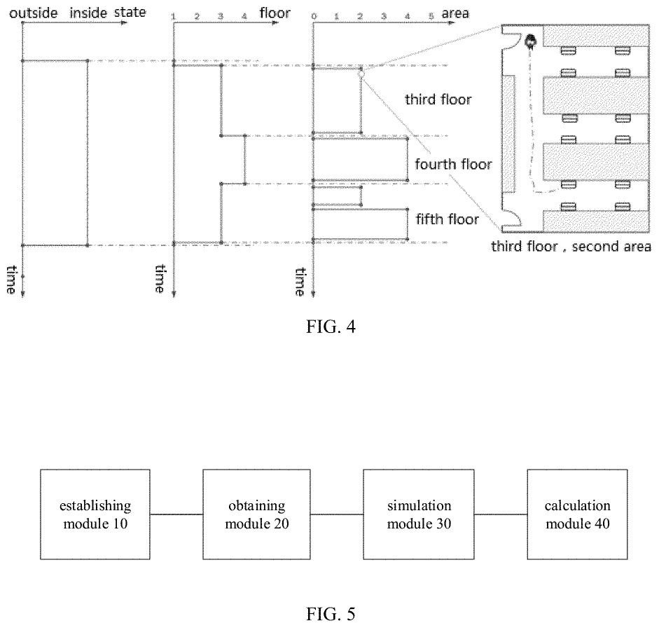

Specifically, as a possible implementation manner of the embodiment of the present disclosure, as shown in FIG. 4, according to a non-homogeneous Markov process, a first state transition matrix of each occupant among the floor nodes is determined, in which the first state transition matrix is time varying. A time period of stay of each occupant at each floor is determined according to the first state transition matrix. According to the non-homogeneous Markov process, a simulation is performed on the time period of stay of each occupant at each floor to determine a second state transition matrix of each occupant among the floor area nodes, in which the second state transition matrix is time varying. A time period of stay of each occupant at each floor area is determined according to the second state transition matrix. According to the non-homogeneous Markov process, a simulation is performed on the time period of stay of each occupant at each floor area to determine a target floor sub-area where each occupant stays and a target position of each occupant in the target floor sub-area. It should be noted that the specific situation of determining the state transition matrix by using the non-homogeneous Markov process is described as follows. Assume that there are n areas inside a building floor, and each area number is 1, 2, . . . , n. The exterior of the building floor is treated as a special area, numbered as 0. These areas constitute a closed topology network with n+1 nodes, each node represents an area, and the location of an occupant is identified by the area node number. When the occupant moves through various areas inside and outside the building, their position status can be regarded as a random variable. If his/her movement range covers all areas, his/her position status values from {0=outside,1=room1,2=room2, , N=roomN}. The position X of the occupant at each moment constitutes a random time sequence {X_{τ}}. This position sequence may be represented by a Markov chain approximately. That is, at any time τ+1, the position of the person X (τ+1) is only related to the position X (τ) at the previous time. The transition probability pᵢⱼ(τ)=P{X_{τ+1}=j|X_{τ}=i} represents a probability that a person is at the position i at the time τ and the position j at the time τ+1, that is, probability that the person departs from the area i at the time moment τ and arrives at area j at the next time moment.

The transition matrix of Markov chain {X_{τ}} composed of all transition probabilities pᵢⱼ is represented in formula (1):

$${P}_{τ} = {( {p}_{ij} )}_{{( n + 1 )}^{*} ( n + 1 )} = ( \begin{matrix}{p}_{10} & ⋯ & {p}_{0 n} \\ ⋮ & ⋱ & ⋮ \\ {p}_{m 0} & ⋯ & {p}_{mn}\end{matrix} ) . \qquad formula ( 1 )$$

Generally, the transition probability pᵢⱼ(τ) is not only related to the state i, j , but also related to the time τ. Therefore, according to the non-homogeneous Markov process, the corresponding state transition matrixes among floor nodes and floor sub-area nodes of each occupant may be determined, and then the time period of each occupant stays in the area may be determined according to the state transition matrixes. By simulating a state transfer position of each occupant in the architectural topology, a target floor sub-area where each occupant stays and a target position of each occupant in the target floor sub-area may be determined.

It is further explained that the simulation method of the occupant movement process follows three general steps of simulation calculation: setting input parameters, simulation calculation, and outputting calculation results. The input parameters of the movement simulation include: the allocation of the number of people in each area of the building, the definition of active events and attribute parameters thereof, the event set of the designated occupant, the simulation period and the time step. The output results include timely information such as the location of occupant, the number of people in the area, and the occurrence of events. The specific steps of the preset simulation algorithm are described as follows.

At step 301, the occupant position status is initialized.

Location statuses of all occupants at time 0 (0:00 on the first day) may be set. For example, for office buildings, the location status is set as outdoor, and for residential buildings, the location status is set as the bedroom.

At step 302, a set of active events at the current moment is determined.

All event collections are searched, and it may be determined whether each event is in an active state according to a start time and an end time of the event, and the current active event collection is updated.

At step 303, an occupant transition matrix at the current moment is determined.

According to the set of active events and the characteristic parameters of each event, the relevant elements of the occupant transition matrix are set and updated.

At step 304, a location of the occupant is calculated.

According to the position of the previous moment and the updated transition matrix, the position of each person at the current moment is predicted and updated with probability.

At step 305, the number of people in the area is determined.

According to the location of all occupants, the number of people in each area may be calculated and updated.

At step 306, the calculation forwards to at the next moment.

The above steps are repeated to obtain the location sequence of each occupant, the status of occupants in respective areas, and the time of each event.

At step 104, an operating energy consumption parameter of the building is calculated according to the state transition position.

Specifically, according to the preset simulation algorithm, the state transition position of each occupant in the architectural topology during the corresponding time period of stay is simulated. According to the state transition position, the position sequence of each occupant and the occupant state of each area can be obtained, as well as the occurrence time of each event. The results may be inputted into building energy consumption calculation and equipment use behavior simulation, and then calculate the building's operating energy consumption parameters. For example, assisting building property managers to estimate the electricity and water consumption of the building, make good use of the exhaust system, safety system, and elevator system to better serve the people in the building.

It needs to be emphasized that in real life, there are many types of people included in the building, such as cleaners, elevator maintenance operators, and office workers, etc., and the status transition positions of different occupants are different, therefore, in order to simulate the transition of occupants more realistically, the schedules of different types of occupants can be obtained as the simulation samples of the present disclosure.

The multi-level occupant movement simulation method of embodiments of the present disclosure solves problems in the prior art such as the requirement of a large number of employed sensors without considering the schedule, individual differences, randomness of occupant movement, and the distribution of occupants in different spatial scales. The present disclosure embodies the hierarchical and multi-scale ideas, saving computer storage space and computing resources, and reflecting the occupant movement characteristics of occupants on different spatial scales.

In order to realize the above embodiments, the present disclosure also provides a multi-level occupant movement simulation apparatus.

FIG. 5 is a schematic structural diagram of a multi-level occupant movement simulation apparatus provided by an embodiment of the present disclosure.

As shown in FIG. 5, the multi-level occupant movement simulation apparatus includes: an establishing module 10, an obtaining module 20, a simulation module 30, and a calculation module 40. The establishing module 10 is configured to establish a multi-level architectural topology according to a structure of a building, in which a first layer of the multi-level architectural topology includes a floor architectural topology, a second layer of the multi-level architectural topology includes a floor area architectural topology, and a third layer of the multi-level architectural topology includes a gridded architectural topology in a floor area. In this embodiment, the establishing module 10 is also configured to construct the floor architectural topology according to a connectivity relation among floors of the building, in which a connectivity relation among floor nodes in the floor architectural topology corresponds to the connectivity relation among the floors; construct the floor area architectural topology according to a connectivity relation among floor areas of the building, in which a connectivity relation of area nodes in the floor area architectural topology corresponds to the connectivity relation among the floor areas; divide each non-corridor area in each floor area into a plurality of floor sub-areas according to a preset size, and construct the gridded architectural topology in the floor area according to the floor sub-areas, in which a connectivity relation of the floor sub-area nodes in the gridded architectural topology corresponds to a connectivity relation among the floor sub-areas. The obtaining module 20 is configured to obtain a schedule of multiple occupants in a simulation experiment. The simulation module is configured to obtain a time period of stay of each occupant of the multiple occupants according to the schedule, and simulate, according to a preset simulation algorithm, the state transition position of each occupant in the multi-level architectural topology during the time period of stay. The simulation module 30 is configured to: determine, according to a non-homogeneous Markov process, a first state transition matrix of each occupant among the floor nodes, wherein the first state transition matrix changes over time; determine a time period of stay of each occupant at each floor according to the first state transition matrix; perform, according to the non-homogeneous Markov process, a simulation on the time period of stay of each occupant at each floor to determine a second state transition matrix of each occupant among the floor area nodes, in which the second state transition matrix changes over time; determine a time period of stay of each occupant at each floor area according to the second state transition matrix; perform, according to the non-homogeneous Markov process, a simulation on the time period of stay of each occupant at each floor area to determine a target floor sub-area where each occupant stays and a target position of each occupant in the target floor sub-area. Finally, the calculation module 40 is configured to calculate an operating energy consumption parameter of the building according to the state transition position.

With the establishing module, the obtaining module, the simulation module, and the calculation module, the multi-level occupant movement simulation apparatus of the embodiments of the present disclosure solves problems in the prior art such as the requirement of a large number of employed sensors without considering the schedule, individual differences, randomness of occupant movement, and the distribution of occupants in different spatial scales. The present disclosure embodies the hierarchical and multi-scale ideas, saving computer storage space and computing resources, and reflecting the occupant movement characteristics of occupants on different spatial scales.

In order to implement the above embodiments, the present disclosure also provides a computer device, including a memory, a processor, and a computer program stored in the memory and running on the processor. When the processor executes the computer program, the multi-level occupant movement simulation methods according to the above embodiments are implemented.

In order to implement the above-mentioned embodiments, the present disclosure also provides a non-transitory computer-readable storage medium. When the computer program is executed by a processor, the multi-level occupant movement simulation methods described in the first aspect of the foregoing embodiments are implemented.

In the description of this specification, descriptions with reference to the terms “one embodiment”, “some embodiments”, “examples”, “specific examples”, or “some examples” etc. mean specific features described in conjunction with the embodiment or example, Structure, materials or features are included in at least one embodiment or example of the present disclosure. In this specification, the schematic representations of the above terms do not necessarily refer to the same embodiment or example. Moreover, the described specific features, structures, materials, or characteristics can be combined in any one or more embodiments or examples in an appropriate manner. In addition, those skilled in the art can combine and combine the different embodiments or examples and the features of the different embodiments or examples described in this specification without contradicting each other.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “a plurality of” means at least two, such as two, three, etc., unless otherwise specifically defined.

Any process or method description in the flowchart or described in other ways herein can be understood as a module, segment or part of code that includes one or more executable instructions for implementing custom logic functions or steps of the process, the scope of the preferred embodiment of the present disclosure includes additional implementations, which may not be in the order shown or discussed, including performing functions in a substantially simultaneous manner or in reverse order according to the functions involved. It is understood by those skilled in the art to which the embodiments of the present disclosure belong.

The logic and/or steps represented in the flowchart or described in other ways herein, for example, can be considered as a sequenced list of executable instructions for implementing logic functions, and can be embodied in any computer-readable medium, for usage by instruction execution systems, devices, or equipment (such as computer-based systems, systems including processors, or other systems that can fetch and execute instructions from instruction execution systems, devices, or equipment), or combine these instruction execution systems, devices or equipment. For the purposes of this specification, a “computer-readable medium” can be any device that can contain, store, communicate, propagate, or transmit a program for use by an instruction execution system, apparatus, or device or in combination with these instruction execution systems, devices, or devices. More specific examples (non-exhaustive list) of computer-readable media include the following: electrical connections (electronic devices) with one or more wiring, portable computer disk cases (magnetic devices), random access memory (RAM), Read only memory (ROM), erasable and editable read only memory (EPROM or flash memory), fiber optic devices, and portable compact disk read only memory (CDROM). In addition, the computer-readable medium may even be paper or other suitable medium on which the program can be printed, because it can be used for example by optically scanning the paper or other medium, followed by editing, interpretation or other suitable manner to obtain the program electronically and then stored in the computer memory.

It should be understood that each part of the present disclosure can be implemented by hardware, software, firmware or a combination thereof. In the above embodiments, multiple steps or methods can be implemented by software or firmware stored in a memory and executed by a suitable instruction execution system. For example, if it is implemented by hardware as in another embodiment, it can be implemented by any one or a combination of the following technologies known in the art: discrete logic gate circuits with logic functions for data signals, application-specific integrated circuits with suitable combinational logic gates, programmable gate array (PGA), field programmable gate array (FPGA), etc.

A person of ordinary skill in the art can understand that all or part of the steps carried in the method of the foregoing embodiments can be implemented by a program instructing relevant hardware to complete. The program can be stored in a computer-readable storage medium. When executed, it includes one of the steps of the method embodiment or a combination thereof.

In addition, the functional units in each embodiment of the present disclosure may be integrated into one processing module, or each unit may exist alone physically, or two or more units may be integrated into one module. The above-mentioned integrated modules can be implemented in the form of hardware or software functional modules. If the integrated module is implemented in the form of a software function module and sold or used as an independent product, it can also be stored in a computer readable storage medium.

The storage medium mentioned above may be a read-only memory, a magnetic disk or an optical disk, etc. Although the embodiments of the present disclosure have been shown and described above, it can be understood that the above-mentioned embodiments are exemplary and should not be construed as limiting the present disclosure. Those of ordinary skill in the art can comment on the above-mentioned embodiments within the scope of the present disclosure. The embodiment undergoes changes, amendments, substitutions and modifications.

What is claimed is:

1. A multi-level occupant movement simulation method, comprising:
establishing a multi-level architectural topology according to a structure of a building, wherein a first layer of the multi-level architectural topology comprises a floor architectural topology, a second layer of the multi-level architectural topology comprises a floor area architectural topology, and a third layer of the multi-level architectural topology comprises a gridded architectural topology in a floor area;
obtaining a schedule of multiple occupants in a simulation experiment;
obtaining a time period of stay of each occupant of the multiple occupants according to the schedule, and simulating, according to a preset simulation algorithm, the state transition position of each occupant in the multi-level architectural topology during the time period of stay; and
calculating an operating energy consumption parameter of the building according to the state transition position.

2. The method according to claim 1, wherein the establishing the multi-level architectural topology according to the structure of the building comprises:
constructing the floor architectural topology according to a connectivity relation among floors of the building, wherein a connectivity relation among floor nodes in the floor architectural topology corresponds to the connectivity relation among the floors;
constructing the floor area architectural topology according to a connectivity relation among floor areas of the building, wherein a connectivity relation of area nodes in the floor area architectural topology corresponds to the connectivity relation among the floor areas;
dividing each non-corridor area in each floor area into a plurality of floor sub-areas according to a preset size, and constructing the gridded architectural topology in the floor area according to the floor sub-areas, wherein a connectivity relation of the floor sub-area nodes in the gridded architectural topology corresponds to a connectivity relation among the floor sub-areas.

3. The method according to claim 2, wherein the obtaining a time period of stay of each occupant of the multiple occupants according to the schedule, and simulating, according to a preset simulation algorithm, the state transition position of each occupant in the multi-level architectural topology during the time period of stay comprise:
determining, according to a non-homogeneous Markov process, a first state transition matrix of each occupant among the floor nodes, wherein the first state transition matrix changes over time; determining a time period of stay of each occupant at each floor according to the first state transition matrix;
performing, according to the non-homogeneous Markov process, a simulation on the time period of stay of each occupant at each floor to determine a second state transition matrix of each occupant among the floor area nodes, wherein the second state transition matrix changes over time;
determining a time period of stay of each occupant at each floor area according to the second state transition matrix;
performing, according to the non-homogeneous Markov process, a simulation on the time period of stay of each occupant at each floor area to determine a target floor sub-area where each occupant stays and a target position of each occupant in the target floor sub-area.

4. The method according to claim 2, wherein the dividing each non-corridor area in each floor area into the plurality of floor sub-areas according to the preset size comprises:
dividing, with a length step size of Δₓ and a width step size of Δ_{y}, each non-corridor area of a length length and a width width into the plurality of floor sub-areas, each floor area has a size of N_{div,x}×N_{div,y}, where
$${N}_{div , x} = \frac{length}{{Δ}_{x}} , {N}_{div , y} = \frac{width}{{Δ}_{y}} .$$

5. The method according to claim 2, wherein the floor nodes comprise nodes of floors, nodes of stairs and nodes of elevators.

6. A multi-level occupant movement simulation apparatus, comprising:
one or more processors;
a memory storing instructions executable by the one or more processors;
wherein the one or more processors are configured to:
establish a multi-level architectural topology according to a structure of a building, wherein a first layer of the multi-level architectural topology comprises a floor architectural topology, a second layer of the multi-level architectural topology comprises a floor area architectural topology, and a third layer of the multi-level architectural topology comprises a gridded architectural topology in a floor area;
obtain a schedule of multiple occupants in a simulation experiment;
obtain a time period of stay of each occupant of the multiple occupants according to the schedule, and simulate, according to a preset simulation algorithm, the state transition position of each occupant in the multi-level architectural topology during the time period of stay; and
calculate an operating energy consumption parameter of the building according to the state transition position.

7. The apparatus according to claim 6, wherein the one or more processors are configured to:
construct the floor architectural topology according to a connectivity relation among floors of the building, wherein a connectivity relation among floor nodes in the floor architectural topology corresponds to the connectivity relation among the floors;
construct the floor area architectural topology according to a connectivity relation among floor areas of the building, wherein a connectivity relation of area nodes in the floor area architectural topology corresponds to the connectivity relation among the floor areas;
divide each non-corridor area in each floor area into a plurality of floor sub-areas according to a preset size, and construct the gridded architectural topology in the floor area according to the floor sub-areas, wherein a connectivity relation of the floor sub-area nodes in the gridded architectural topology corresponds to a connectivity relation among the floor sub-areas.

8. The apparatus according to claim 7, wherein the one or more processors are configured to:
determine, according to a non-homogeneous Markov process, a first state transition matrix of each occupant among the floor nodes, wherein the first state transition matrix changes over time;
determine a time period of stay of each occupant at each floor according to the first state transition matrix;
perform, according to the non-homogeneous Markov process, a simulation on the time period of stay of each occupant at each floor to determine a second state transition matrix of each occupant among the floor area nodes, wherein the second state transition matrix changes over time;
determine a time period of stay of each occupant at each floor area according to the second state transition matrix;
perform, according to the non-homogeneous Markov process, a simulation on the time period of stay of each occupant at each floor area to determine a target floor sub-area where each occupant stays and a target position of each occupant in the target floor sub-area.

9. A non-transitory computer-readable storage medium with a computer program stored thereon, wherein the computer program implements a multi-level occupant movement simulation method when the computer program is executed by a processor, and the method comprises:
establishing a multi-level architectural topology according to a structure of a building, wherein a first layer of the multi-level architectural topology comprises a floor architectural topology, a second layer of the multi-level architectural topology comprises a floor area architectural topology, and a third layer of the multi-level architectural topology comprises a gridded architectural topology in a floor area;
obtaining a schedule of multiple occupants in a simulation experiment;
obtaining a time period of stay of each occupant of the multiple occupants according to the schedule, and simulating, according to a preset simulation algorithm, the state transition position of each occupant in the multi-level architectural topology during the time period of stay; and
calculating an operating energy consumption parameter of the building according to the state transition position.
